(19) United States
(12) Patent Application Publication
(10) Pub. No.: US 2002/0073681 A1
(43) Pub. Date: Jun. 20, 2002

(54) Mechanical rake with sweep

(76) Inventors: Michael O. Roser, Bellevue, WA (US); Kelly C. Sheehan, Mercer Island, WA (US)

Correspondence Address: Seed Intellectual Property Law Group PLLC, Suite 6300, 701 Fifth Avenue, Seattle, WA, 98104-7092, US

(21) Appl. No.: 09/737,386

(22) Filed: Dec. 14, 2000

(51) Int. Cl. A01D 7/00

(52) U.S. Cl. 56/400.12; 56/400.19

(57) ABSTRACT

A combination tool in the form of a mechanical rake having a sweep that includes a handle, a rake head mounted on the handle, and a sweep assembly cooperating with the rake head to move between an opened configuration and a closed configuration for picking up material. The sweep assembly includes a flexible sweep member having a planar configuration and form of resilient material that tapers in thickness to a distal end and that conforms to the shape of the ground when pushed there against and flexes to move the rake tines forward and when unflexing pulls the rake tines toward the sweep that is then moved into the closed position for picking up the material. To facilitate normal use of the rake tines, the sweep assembly is held in a normally-closed position. Interchangeable rake heads with different tine configurations provide more versatility, and the tines themselves have an extended length in the range of two to four inches.

### TECHNICAL FIELD

The present invention pertains to a tool for raking and collecting material, and, more particularly, to a mechanical rake having a sweep assembly that cooperates with a rake head for picking up material.

### BACKGROUND OF THE INVENTION

A number of implements have been proposed to facilitate the raking and collection of leaves, grass, yard debris, and the like. One such device is found in U.S. Pat. No. 3,105,348, entitled Garden Rake with Material Retaining Means, which uses a rake in combination with a clamping plate designed to fit around the rake to collect and hold material against the teeth of the rake. The clamping plate is rotated by a lever pivotally attached to the rake handle. Although this design may work for its purpose, it is large and cumbersome by today's standards, is not cost-effective to manufacture, does not include any provision for holding the clamping plate against the rake teeth when not in use, and is difficult to operate.

Another proposed design is found in U.S. Pat. No. 2,504,943, issued to M. F. Zifferer on Apr. 18, 1950, for a Pick-up Broom Rake. This device uses two rake heads, one of which is fixed and the other operable to swing into engagement with the first rake. An operating rod having a coiled handle slides on the rake handle to move the swinging rake head. An expansible spring is connected between the fixed rake and the operable rod to hold the swinging rake in a closed position. The use of two rake heads with large spaces between the tines has the disadvantage of allowing smaller-sized debris to fall through the spaces. The external expandable spring design is difficult to manufacture, assemble, and maintain.

Hence, there is a need for a raking tool that is easy to manufacture, light weight, and uncomplicated in its use and maintenance.

### SUMMARY OF THE INVENTION

The present invention is directed to a mechanical rake that includes a handle, a rake head mounted on a distal end of the handle, and a sweep assembly cooperating with the rake head to move between a closed configuration and an opened configuration in conjunction with the rake head to pick up material. The sweep assembly includes a flexible sweep having a planar configuration and formed of resilient material that conforms to the shape of the ground and flexes to aid in collecting material and urging the sweep assembly to move into the closed configuration with the rake head.

In accordance with another aspect of this embodiment of the invention, the sweep assembly includes a slideable hand grip mounted on the handle for movement along a longitudinal axis of the handle and an actuator rod coupled to the sweep and attached to the slideable hand grip to move the sweep in response to movement of the slideable hand grip. Ideally, a fixed hand grip is attached to the longitudinal handle and has a longitudinal bore sized to receive the actuator rod in slideable engagement without inhibiting movement of the actuator rod. Interchangeable rake heads with different tine configurations can be provided to enhance versatility.

In accordance with another aspect of the disclosed embodiments of the invention, a compression spring is mounted over the actuator rod and has a first end bearing against the fixed hand grip and a second end bearing against the slideable hand grip to urge the sweep assembly into the closed configuration.

In accordance with another aspect of the disclosed embodiments of the present invention, a method for using the mechanical rake described above is provided. The method includes moving the sweep assembly into the opened configuration, pushing the sweep into contact with the ground with sufficient force to cause flexing of the sweep member and forward movement of the rake tines; and

removing the force to allow the sweep member to return to its normal shape and to urge the rake tines to move rearward and towards the closed configuration with the sweep assembly to thereby aid in picking up material.

In accordance with another aspect of this embodiment of the invention, the method further comprises moving the slideable hand grip to bring the sweep and rake into the closed configuration.

As will be readily appreciated from the foregoing, the disclosed embodiments of the present invention provide a mechanical rake with sweep that is easier to manufacture, less complicated to use and maintain, and has a substantially solid, imperforate sweep to facilitate collection and removal of debris of even the smallest size.

### BRIEF DESCRIPTION OF THE DRAWINGS

The foregoing and other features and advantages of the disclosed embodiments of the present invention will be more readily understood from the following detailed description when taken in conjunction with the accompanying drawings, wherein:

FIG. 1 is a top plan view of a mechanical rake formed in accordance with one embodiment of the present invention;

FIG. 2 is a side plan view of the mechanical rake of FIG. 1;

FIG. 3 is an enlarged side view of the rake head and sweep showing the closed configuration and, in phantom, the opened configuration;

FIG. 4 is a top plan view of the rake head;

FIGS. 5A and 5B are a top plan view and a sideview, respectively, of the sweep;

FIGS. 6A through 6D are a sequence of side views showing the method of using the mechanical rake in accordance with the present invention; and

FIGS. 7A through 7D illustrate another embodiment of the mechanical rake utilizing an exchangeable rake head.

### DETAILED DESCRIPTION OF THE INVENTION

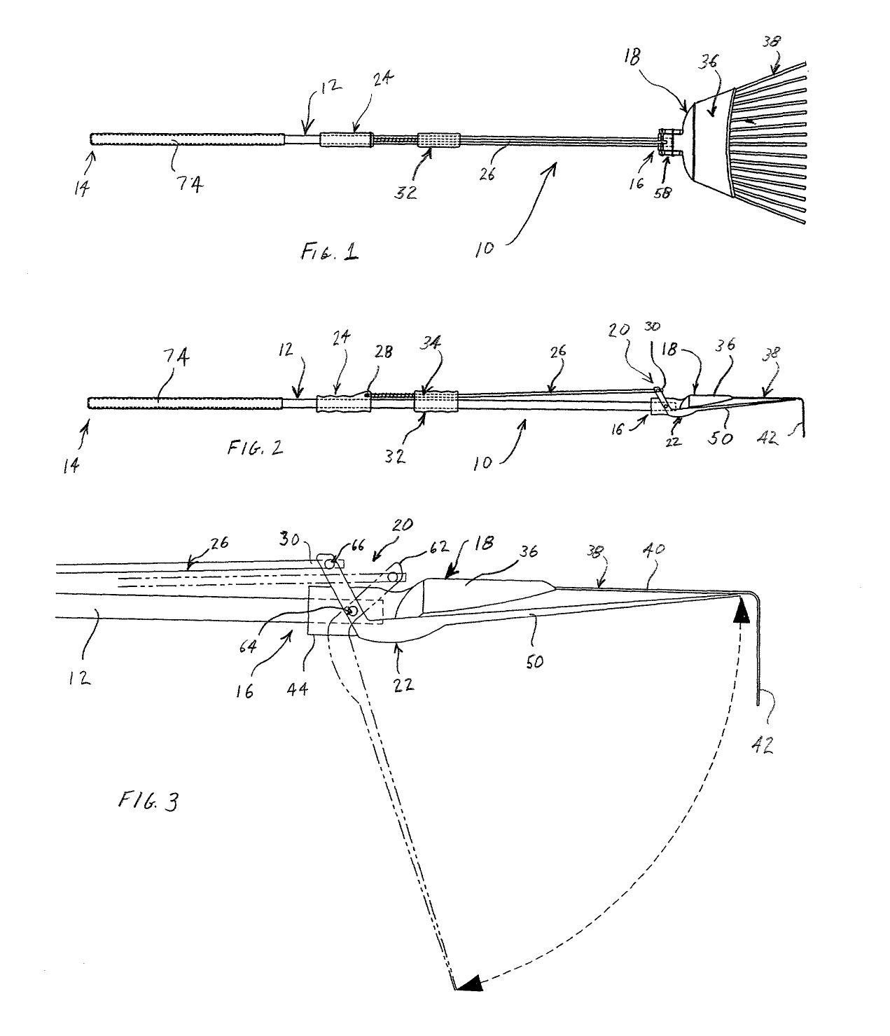

Referring initially to FIGS. 1 and 2, shown therein is a combination tool 10 in the form of a mechanical rake with sweep. The tool 10 has a handle 12 with a proximal end 14 and a distal end 16. The handle 12 has an elongate shape with a longitudinal axis and may be formed from wood, plastic, metal, or other suitable material.

At the distal end 16 of the handle 12 is a rake head 18 that, in this embodiment, is fixedly attached to the handle 12 with a fastening means, such as epoxy, nails, or screws, or in other ways known to those skilled in the art, and which is not shown herein. Alternatively, the rake head 18 may be integrally formed with the handle 12, such as by injection molding.

Associated with the distal end 16 of the handle 12 is a sweep assembly 20 that moves between a closed configuration (shown in solid lines in FIG. 3) and an opened configuration (shown in phantom lines in FIG. 3) for picking up material in cooperation with the fixed rake head 18.

The sweep assembly 20 includes a sweep 22 coupled to the rake head 18, a slideable hand grip 24 mounted slideably on the handle 12, and an actuator rod 26. The actuator rod 26 has a proximal end 28 attached to the slideable hand grip 24 and a distal end 30 coupled to the sweep 22 to move the sweep 22 in response to movement of the slideable hand grip 24. In a preferred embodiment, the sweep assembly 20 also includes a fixed hand grip 32 attached to the handle at a location distal to the slideable hand grip 24. The fixed hand grip 32 has a longitudinal bore 34 through which the actuator rod 26 slideably passes without restriction. The fixed grip 32 thus provides support and guidance for the actuator rod 26 and a place for a user to grasp the handle 12 without interfering with the movement of the actuator rod 26.

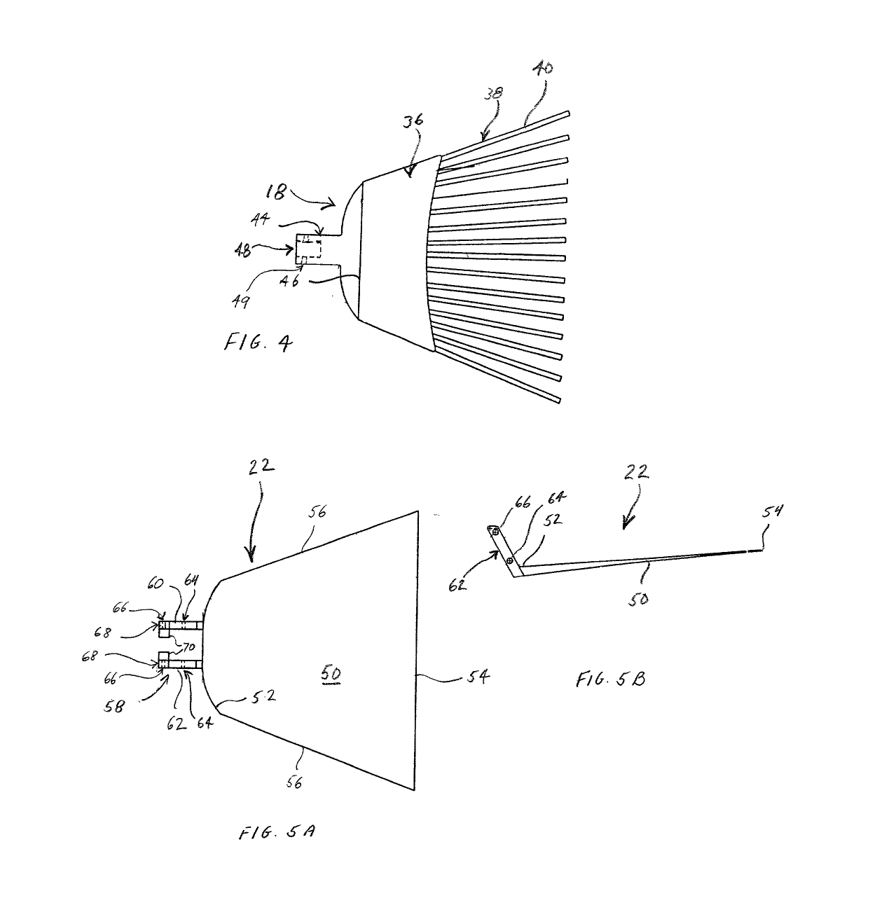

Referring next to FIGS. 4 and 5A-5B, shown in greater detail therein are the rake head 18 and the sweep 22, respectively. Turning first to FIG. 4, the rake head 18 comprises a body 36 having a plurality of rake tines 38 projecting therefrom. The tines 38 may be of the thick, rigid type, such as is used for garden raking, or they may be of the flat, resilient type used for lawn and leaf raking. In the embodiment shown and described herein, the tines 38 are formed of resilient material and are shaped and sized for lawn and leaf raking the construction of which is known in the art.

More particularly, each time 38 has an arm portion 40 projecting outward from the body 36 and a finger portion 42 extending at an angle of about 90° from the arm portion 40. Ideally, there are in the range of 18 to 20 tines on the rake head 18, although more or less tines may be used. Each finger portion 42 has a length in the range of one to four inches. While conventional tines have finger portions with a length in the range of one and one-half to two inches, the preferred embodiment of the present invention has finger portions 42 with a length in the range of two to four inches.

In the illustrated embodiment, the rake head 18 also includes a cylindrical projection 44 extending from a back 46 of the body 36 in a direction opposite to that of the tines 38. The projection 44 has a longitudinal axial bore 48 sized and shaped to receive the distal end 16 of the handle 12. A transverse opening 49 may be formed in the projection 44 that intersects with the bore 48 for use in mounting the sweep 22 to the rake head 18 and handle 12.

The sweep 22, shown in greater detail in FIGS. 5A and 5B, has a substantially flat, solid scoop 50 that tapers in thickness from a back wall 52 to a front edge 54, as shown in the side view of FIG. 5B. In the top view of FIG. 5A, it can be seen that the scoop 50 has a trapezoidal plan form shape wherein the lateral sides 56 each taper towards the back wall 52. There are no upturned side walls on the sides 56 of the scoop 50 or other projections that interfere with the scoop 50 nesting under the tines 38 of the rake head 18 when the tool 10 is in the closed configuration. This construction of the scoop 50 enables flexing of the scoop 50 about a transverse axis and conforming of the scoop 50 to the ground when the front edge 54 is pressed against the ground, as described in more detail below. Thus, the sweep 22 is preferably formed of flexible, resilient material to enable flexing about its transverse axis and returning to its original shape.

Extending from the back wall 52 of the scoop 50 is a yoke 58 that is sized and shaped to be rotatably mounted over the projection 44 on the rake head 18. The yoke 58 includes first and second arms 60, 62 that extend back away from the scoop 50 at an angle in the range of 110° to 120° and, preferably, at 114° as shown in FIG. 5B. A first transverse opening 68 in each arm 60, 62 is used to mount the sweep 22 for rotation to the rake head 18 and the handle 12. A second transverse opening 66 positioned above the first transverse opening is used to attach the sweep 22 to the distal end 30 of the actuator rod 26. The free ends 68 of the first and second arms 60, 62 each have a thicker portion or hub 70 to provide a reinforced and more narrow mounting area for the actuator rod 26.

While the scoop 50 has a solid construction to facilitate the picking up of small objects, the scoop 50 may have one or more very small openings or a fine grid construction to permit the drainage of liquids.

The connection of the sweep assembly 20 and the rake head 18 is shown in detail in FIG. 3. The rake head 18 is slid over the distal end 16 of the handle 12, and the yoke 50 on the sweep 22 is placed over the projection 44 on the rake head 18. The first transverse openings 64 in each arm 60, 62 of the yoke 50 are aligned with the transverse openings 49 in the rake head 18 to accommodate one or two fastening devices (not shown) that fixably attach the rake head 18 to the handle 12 and rotatably couple the sweep 22 to the rake head 18.

The distal end 30 of the actuator rod 26 is rotatably coupled to the yoke 50 with a suitable fastener (not shown). The proximal end of the actuator rod is fixably attached to the slideable hand grip 24, as shown in FIGS. 1 and 2, such that movement of the slideable hand grip 24 along the longitudinal axis of the handle 12 and towards the rake head 18 causes the sweep 22 to move into the opened configuration with respect to the rake head 18, and movement of the slideable hand grip 24 away from the rake head 18 causes the sweep 22 to move into a closed configuration with the rake head 18. The fixed hand grip 32 supports and guides the actuator rod 26 as it moves. Movement of the sweep 22 is limited by contact of the scoop 50 with the rake head in the closed configuration, and by the limit of travel of the yoke 50 on the rake head 18 and the flexible hand grip 26 on the handle 12 in the opened configuration.

To maintain the sweep assembly 20 in the closed configuration, a coil spring 68 is preferably mounted over the actuator rod 26. The fixed hand grip 32 acts as a stop for the spring 68 such that the coil spring 68 urges the slideable hand grip 24 away from the fixed hand grip 32 with sufficient force to keep the sweep 22 tucked under the tines 38 on the rake head 18.

In use, the sweep assembly 20 is maintained in a normally-closed configuration by the coil spring 68 acting on the slideable hand grip 24. A user grasps the handle 12 and rakes material in a conventional manner. To pick up material, the user slides the slideable hand grip 24 towards the rake head 18 to move the sweep 22 into the opened configuration. Material raked into a pile can then be collected with the scoop 50 and held against the tines 38 by moving the sweep 22 towards the closed configuration. Material captured between the tines 38 and the sweep 22 can then be moved as desired and released by sliding the slideable hand grip 24 towards the rake head 18 to move the sweep 22 to the opened configuration.

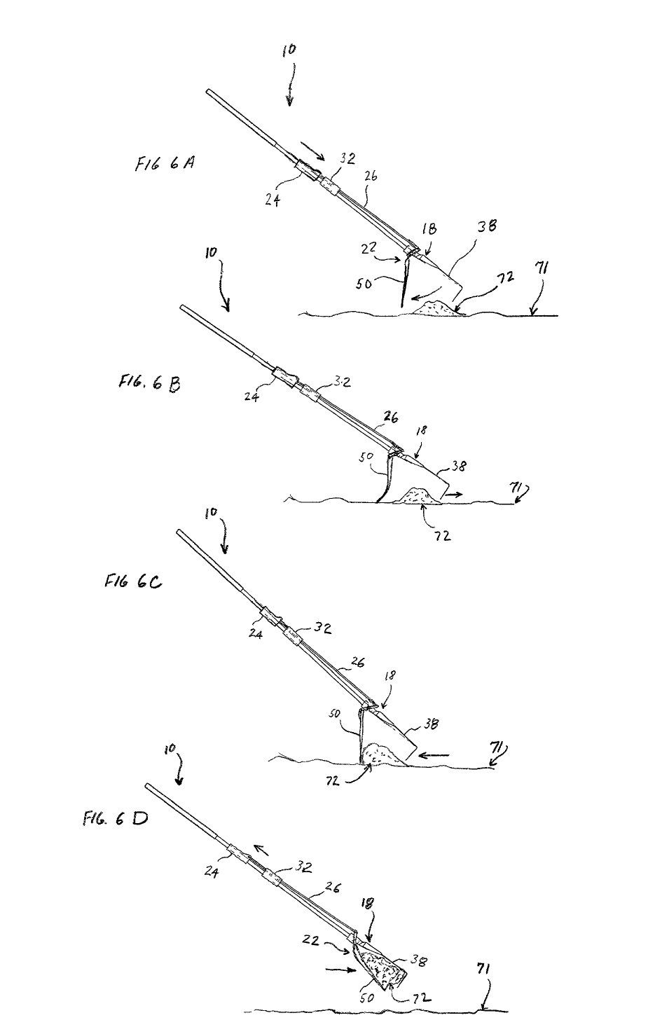

In an alternative method of using the tool 10, as shown in FIGS. 6A through 6D, the tool 10 is used in a manner that the sweep 22 flexes to aid in collecting material and urging the sweep assembly and rake head 18 to move towards each other and towards the closed configuration. Initially, after raking, the sweep 22 is moved to the opened configuration as described above and as shown in FIG. 6A. The front edge 54 of the scoop 50 is then pushed against the ground 71, as shown in FIG. 6B, with sufficient force that the scoop 50 conforms to the ground 71 flexes inward towards the rake head 18.

Flexing of the scoop 50 causes the rake tines 38 to move forward as shown by the arrows in FIG. 6B. The tines 38 are then brought into engagement with the ground 71 or the material 72 to be raked, or both, and the flexed scoop is permitted to unflex in a manner that pulls the rake tines 38 and the sweep 22 towards each other, as shown in FIG. 6C, and thus moving the sweep 22 and the rake head 18 towards the closed configuration. Material 72 located between the rake tines 38 and the scoop 50 is then collected and captured by moving the slideable hand grip 24 away from the rake head 18, bringing the sweep 22 and the rake head 18 into closer proximity, as shown in more detail in FIG. 6D. The captured material 72 can then be moved and released as described above.

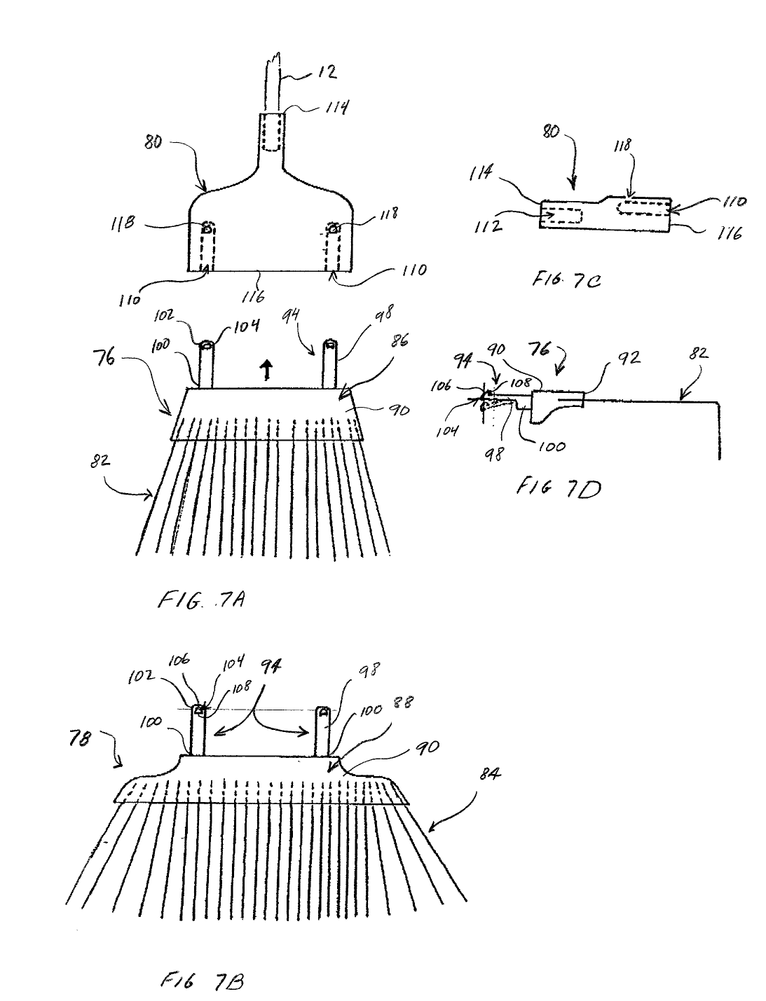

While a preferred embodiment of the invention has been illustrated and described, it is to be understood that various changes may be made therein without departing from the spirit and scope of the invention. For example, a grip 74 may be placed on the proximal end 14 of the handle 12 to facilitate gripping of the handle 12 by the user and to provide greater comfort to the user. Interchangeable rake heads may be used to increase the versatility of the tool 10. Shown in FIGS. 7A through 7D is another embodiment of the tool 10 having first and second interchangeable rake head attachments 76 and 78, respectively, structured for releasable connection to a base member 80 that is fixedly attached to the handle 12. Each attachment 76, 78 has a set of rake tines 82, 84, respectively attached to and extending from a head piece 86, 88. As shown in FIGS. 7A and 7B, the first rake head attachment 76 has fewer tines 82 extending from the head piece 86 in a less spread-out and more narrow arrangement than the tines 84 extending from the head piece 88 in the second rake head attachment 78. This facilitates raking and collection of debris around shrubs and plants.

Each head piece 86, 88 has a body member 90, as shown in FIG. 7D, with the tines extending from a forward side 92 and two bayonet-style connectors 94 extending from a rearward side 96. The connectors 94 include a prong 98 having a first end 100 attached to or integrally formed with the rearward side 96 of the body member 90. A second end 102 of the prong 98 is formed to have a projection 104 extending outward therefrom. The projection includes an angled face 106 to facilitate engagement with the base member 80 and a perpendicular face 108 to retain the prong 98 in locking engagement with an opening 110 formed in the base member 80. Ideally, the prongs 98 are formed of resilient material to enable slight bonding of the prongs 98, as shown in FIG. 7D.

Shown in FIG. 7C is the base member 80 having a handle opening 112 for receiving the handle 12 at a rearward side 114 and two openings 110 formed in a forward side 116 of the base member 80, each sized and shaped to receive the prong 98. A top opening 118 intersects the opening 110 and is sized and shaped to allow the projection 104 to extend there through in locking engagement.

In use, the prongs 98 are slid into the openings 110 until the projections 104 snap into place in the top openings 118. Pressing the projections 104 down into the openings 110 enables removal of the prongs 98 and disengagement of the attachment from the base member 80.

Thus, the invention is to be limited only by the scope of the claims that follow and the equivalents thereof.

We claim:

1. A mechanical rake with sweep, comprising:
a handle;
a rake head mounted on a distal end of the handle; and
a sweep assembly cooperating with the rake head to move between an opened configuration and a closed configuration to collect material in conjunction with the rake head, the sweep assembly comprising a flexible sweep having a planar configuration and formed of resilient material that conforms to the shape of the ground and flexes when in the opened configuration to urge the sweep assembly and the rake head to move together.

2. The rake of claim 1, further comprising an apparatus for holding the sweep assembly in the closed configuration.

3. The rake of claim 1, wherein the sweep has a back wall and a front edge and a thickness, that tapers from the back wall to the front edge.

4. The rake of claim 1, wherein the sweep assembly comprises a slideable handgrip mounted on the handle for movement along a longitudinal axis of the handle and an actuator rod coupled to the sweep and attached to the slideable handgrip to move the sweep in response to movement of the slideable handgrip.

5. The rake of claim 4, wherein the sweep assembly comprises a fixed handgrip attached to the longitudinal handle and having a longitudinal bore sized to receive the actuator rod in slideable engagement.

6. The rake of claim 5, wherein the fixed handgrip is attached to the handle between the sweep and the slideable handgrip, the rake further comprising a compression spring mounted over the actuator rod and having a first end bearing against the fixed handgrip and a second end bearing against the slideable handgrip to urge the sweep assembly into the closed configuration.

7. The rake of claim 1, wherein the rake head comprises a base member and at least two interchangeable head members, the body configured for fixed attachment to the handle and each head member configured for releasable connection to the base member.

8. The rake of claim 1, wherein the rake head comprises a plurality of tines, each tine having a first portion attached to the rake head and a second portion extending at an angle from the first portion and having a length in the range of two to four inches.

9. A mechanical rake, comprising:
an elongate handle having a longitudinal axis and a first end and a second end;
a rake head mounted on the second end of the handle and including a plurality of rake tines projecting therefrom; and
a sweep assembly associated with the second end of the handle and cooperating with the rake head to move between an opened configuration and a normally-closed configuration to collect material, the sweep assembly comprising a flexible sweep member having a substantially planar configuration formed of solid, resilient material that, when pushed with sufficient force against the ground in the opened configuration conforms to the shape of the ground and flexes to move the rake tines forward, and when the force is removed, returns to its original shape, urging the rake tines and the sweep member to move together towards the closed configuration.

10. The rake of claim 9, comprising an apparatus for holding the sweep assembly and the rake head in the normally-closed configuration.

11. The rake of claim 9, wherein the sweep assembly comprises a slideable handgrip mounted to the handle for movement along the longitudinal axis of the handle, and an actuator rod having a first end attached to the slideable handgrip and a second end coupled to the sweep member.

12. The rake of claim 9, comprising a fixed handgrip mounted to the handle between the slideable handgrip and the rake head, the fixed handgrip having a longitudinal bore sized and shaped to receive the actuator rod in slideable engagement.

13. The rake of claim 12, comprising a coil spring mounted over the actuator rod between the slideable handgrip and the fixed handgrip to urge the sweep assembly into the normally-closed configuration.

14. The rake of claim 9, wherein the rake head comprises a base member fixedly attached to the handle, and further comprising at least two interchangeable head members each head member configured for releasable attachment to the base member.

15. The rake of claim 14, wherein the plurality of rake tines each comprise a first portion attached to the head member and a second portion extending at an angle from the first portion, the second portion of each rake tine stet a length in the range of two to four inches.

16. The rake of claim 14, wherein a first interchangeable head is structured to have a first width to enable raking between shrubs, and wherein a second head has a second width wider than the first width to facilitate raking of leaves and yard debris.

17. A method of using a mechanical rake that includes an elongate handle having a longitudinal axis and a first end and a second end, a rake head mounted on the second end of the handle and including a plurality of rake tines projecting therefrom, and a sweep assembly associated with the second end of the handle to move between an opened configuration and a closed configuration to capture material in cooperation with the rake head, the sweep assembly comprising a flexible sweep member having a substantially planar configuration formed of solid, resilient material that, when pushed with sufficient force against the ground in the opened configuration, conforms to the shape of the ground and flexes to move the rake tines forward, and when the force is removed, returns to its original shape, urging the rake tines and sweep assembly to move together towards the closed configuration, the method comprising:
moving the sweep assembly into the opened configuration;
pushing the sweep member into contact with the ground with sufficient force to cause flexing of the sweep member and forward movement of the rake tines; and
removing the force to allow the sweep member to return to its normal shape and to urge the rake tines to move towards the sweep member to capture material between the sweep member and the rake head.

18. The method of claim 17, further comprising, after removing the force, moving the slideable handgrip to bring the sweep member into the closed configuration with the rake head.

19. The method of claim 17, comprising initially maintaining the sweep assembly in the closed configuration with a spring-actuated slideable handgrip.
